(19) United States
(12) Patent Application Publication
(10) Pub. No.: US 2026/0336168 A1
(43) Pub. Date: Oct. 29, 2026

(54) METHOD AND DEVICE FOR SEPARATING PARTICLES COMPRISING PLASTIC PARTICLES

(71) Applicant: D&G Recycling GmbH, Nördlingen (DE)

(72) Inventors: Jürgen Deinert, Duderstadt (DE); Gordon Egert, Duderstadt (DE)

(21) Appl. No.: 19/701,705

(22) Filed: Jun. 8, 2026

Related U.S. Application Data
(63) Continuation of application No. PCT/EP2024/085263, filed on Dec. 9, 2024.

(30) Foreign Application Priority Data
Dec. 13, 2023 (EP) 23 216 365.9

(51) Int. Cl. B29B 17/02; B03C 1/023; B03C 1/23; B03C 1/30; B03C 7/00; B03C 7/08; B29B 17/00

(52) U.S. Cl. CPC B29B 17/02; B03C 1/023; B03C 1/23; B03C 1/30; B03C 7/003; B03C 7/08; B03C 2201/18; B03C 2201/20; B29B 2017/0015; B29B 2017/0244; B29B 2017/0265; B29B 2017/0272

(57) ABSTRACT

A method for separating particles comprising plastic particles of different compositions comprises subjecting the particles, which have previously been in contact with a liquid, to drying so as to remove the liquid therefrom; subjecting the particles to electrostatic charging after the drying; separating the particles, after the electrostatic charging, into different fractions depending on at least one of specific electrostatic charges or electrical conductivities of the particles, wherein the particles of one fraction of the different fractions exhibit no electrostatic charges; and again subjecting at least a portion of the one fraction, the particles of which exhibit no electrostatic charges after the electrostatic charging, to drying and subsequent electrostatic charging, wherein the portion comprises plastic particles comprising residual moisture from the liquid, and thereafter separating the portion into the different fractions depending on the at least one of specific electrostatic charges or electrical conductivities of the particles thereof.

### CROSS REFERENCE TO RELATED APPLICATIONS

This application is a continuation of International Application PCT/EP2024/085263 with an international filing date of Dec. 9, 2024 and claiming priority to European Patent Application No. EP 23 216 365.9 entitled “Verfahren und Vorrichtung zur Trennung von Teilchen, die Kunststoffteilchen verschiedener Zusammensetzungen umfassen”, filed on Dec. 13, 2023.

### FIELD

The present disclosure relates to a method and an apparatus for separating particles comprising plastic particles of different compositions.

### BACKGROUND

For separating particles comprising plastic particles of different compositions, the use of a so-called electrostatic separator is known. In an electrostatic separator, the particles are electrostatically charged, for example by means of an electrical discharge, and are subsequently separated into different fractions depending on their specific electrostatic charges and/or electrical conductivities.

It is known that the moisture content of plastic particles has a significant influence on their electrostatic chargeability. Therefore, particles comprising plastic particles which have been in contact with a liquid must be dried prior to their separation in an electrostatic separator. This applies, for example and in particular, when the particles have previously been suspended in the liquid in order to distinguish them with respect to their density by means of said liquid. The drying of all plastic particles must typically be carried out down to a residual moisture content of at most 0.2 percent by weight in order that they can subsequently be separated with respect to their compositions by means of an electrostatic separator. In order for all plastic particles contained in the particles to exhibit this low residual moisture content, drying of the particles requires a long drying time and/or a high energy input.

A method and an apparatus for separating particles comprising plastic particles of different compositions are known from registered German utility model DE 20 2021 000 353 U1.

There still is a need of a method for separating particles comprising plastic particles of different compositions and an apparatus for carrying out such a method, which exhibit a reduced energy requirement for drying the particles.

### SUMMARY

The present invention relates to a method for separating particles comprising plastic particles of different compositions. The method comprises subjecting the particles, which have previously been in contact with a liquid, to drying so as to remove the liquid therefrom; subjecting the particles to electrostatic charging after the drying; and separating the particles, after the electrostatic charging, into different fractions depending on at least one of specific electrostatic charges or electrical conductivities of the particles, wherein the particles of one fraction of the different fractions exhibit no electrostatic charges. The method further comprises again subjecting at least a portion of the one fraction, the particles of which exhibit no electrostatic charges after the electrostatic charging, to drying and subsequent electrostatic charging, wherein the portion comprises plastic particles comprising residual moisture from the liquid, and thereafter separating the portion into the different fractions depending on the at least one of specific electrostatic charges or electrical conductivities of the particles thereof.

The present invention also relates to an apparatus for separating particles comprising plastic particles of different compositions. The apparatus comprises a dryer configured to subject particles, which have previously been in contact with a liquid, to drying; a charging device configured to subject the particles, after the drying in the dryer, to electrostatic charging; a fractionating device configured to separate the particles, after the electrostatic charging, into different fractions depending on at least one of specific electrostatic charges or electrical conductivities of the particles, wherein the particles of one fraction of the different fractions exhibit no electrostatic charges; and a return device configured to return at least a portion of the one fraction, the particles of which exhibit no electrostatic charges, back into the dryer or into a further dryer connected to the charging device, wherein the portion comprises plastic particles comprising residual moisture from the liquid, such that the portion of the one fraction is again subjected to drying, subsequent electrostatic charging, and subsequent separation into the different fractions.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The present disclosure can be better understood with reference to the following drawings. The components in the drawings are not necessarily to scale, emphasis instead being placed upon clearly illustrating the principles of the present disclosure. In the drawings, like reference numerals designate corresponding parts throughout the several views.

FIG. 1 is a flow diagram of an embodiment of the method according to the present disclosure and simultaneously shows a structure of the apparatus according to the present disclosure; and

FIG. 2 illustrates a concrete embodiment of an electrostatic separator for use in the method and the apparatus according to FIG. 1.

### DETAILED DESCRIPTION

In the method according to the present disclosure for separating particles comprising plastic particles of different compositions, the particles, which have previously been in contact with a liquid, are subjected to drying in order to remove the liquid therefrom. After drying, the particles are subjected to electrostatic charging. Subsequently, the particles are separated into different fractions depending on their specific electrostatic charges and/or electrical conductivities, wherein the particles of one of the different fractions exhibit no electrostatic charges. At least a portion of said one fraction, the particles of which exhibit no electrostatic charges, wherein said portion comprises plastic particles comprising residual moisture from the liquid, is again subjected to drying and subsequent electrostatic charging and is then separated into the different fractions depending on the specific electrostatic charges and/or electrical conductivities of its particles.

The term electrostatic charges herein refers to the net charges of the particles resulting from the sum of the positive and negative electrostatic charges. The statement that a particle exhibits no electrostatic charge also includes the case in which the electrostatic charge of the particle is so small that, within the scope of the method according to the present disclosure, the particle is indistinguishable from a particle having an electrostatic charge of exactly zero.

The one fraction, the particles of which exhibit no electrostatic charges, i.e. which were either not electrostatically charged at all or quickly lost their electrostatic charges again, contains the plastic particles whose residual moisture is too high to electrostatically charge them. These plastic particles comprising residual moisture therefore cannot be separated from other particles on the basis of their plastic composition and the resulting dielectric properties. In the method according to the present disclosure, at least a portion of said one fraction, the particles of which exhibit no electrostatic charges, namely the portion comprising the plastic particles comprising residual moisture from the liquid, is again subjected to drying and subsequent electrostatic charging and is then separated into the different fractions depending on the specific electrostatic charges and/or electrical conductivities of its particles. This can be realized in a simple manner in that this portion of said one fraction is added to the particles which are subjected to drying for the first time. During the repeated drying, the residual moisture of the plastic particles which exhibited no electrostatic charges during the first separation into the fractions because their residual moisture was still too high is reduced. The reduced residual moisture may result in these plastic particles being electrostatically charged during the subsequent electrostatic charging to such an extent and with such persistence that they are not again transferred into said one fraction, the plastic particles of which exhibit no electrostatic charges, but rather into another fraction depending on their plastic composition and the resulting dielectric properties.

With this procedure, the drying to which all particles are subjected at least once can be carried out relatively quickly and with a relatively low expenditure of energy. In this case, it is accepted that not even approximately all contained plastic particles are dried to the residual moisture level sufficient for electrostatic separation. Instead, care is taken to ensure that, as selectively as possible, the plastic particles still comprising residual moisture are subjected to repeated drying, i.e. additional energy for drying is expended only for these particles comprising residual moisture. Since a very large amount of energy can thereby be saved during the drying to which all particles are subjected, a high energetic advantage is achieved even if some of the particles are subjected to drying more than twice, even if these particles are not exclusively plastic particles comprising residual moisture but enter the fraction whose particles exhibit no electrostatic charges due to other properties.

The fraction whose particles exhibit no electrostatic charges comprises, in addition to plastic particles having a high residual moisture content of the liquid, metal particles and/or plastic particles having a high metal content, as well as plastic particles comprising plastic rendered electrically conductive in another manner. These particles can in some cases be electrostatically charged, but then lose their charges again very quickly, such that they are assigned to said one fraction as particles exhibiting no electrostatic charges.

In order to subject, from or with said one fraction whose particles exhibit no electrostatic charges, as far as possible only plastic particles comprising residual moisture to repeated drying and the subsequent process steps, ferromagnetic and/or electrically conductive particles may be separated off before the portion of said one fraction is again subjected to drying. The ferromagnetic and/or electrically conductive particles may be separated off only after said one fraction has been separated and/or beforehand from the particles.

Ferromagnetic particles, which include ferromagnetically modified plastic particles as well as ferromagnetic metal particles, may, for example, be separated off by means of an electromagnet. This corresponds to the operating principle of a fundamentally known so-called magnetic separator.

Electrically conductive particles may, for example, be separated off by inducing eddy currents in the electrically conductive particles. The eddy currents generate a magnetic field such that the electrically conductive particles are accelerated away from other, i.e. non-electrically conductive, particles through interaction with an external magnetic field. This corresponds to the operating principle of a fundamentally known so-called eddy current separator. In the simplest case, the particles are moved transversely to the field lines through a magnetic field, wherein selectively the electrically conductive particles are decelerated according to the principle of an eddy current brake. The separation of the ferromagnetic and electrically conductive particles may in principle be carried out simultaneously, i.e. for example by means of the same electromagnet.

Furthermore, particles exhibiting an electrical polarizability different from that of plastic particles comprising residual moisture from the liquid may be separated off from said one fraction or already beforehand before at least the portion of said one fraction is again subjected to drying. This may be realized in that the particles are moved through an inhomogeneous external electric field in order to deflect the particles differently depending on their electrical polarizability through interaction with the inhomogeneous external electric field. By means of the external electric field, an electrical polarization of the particles is caused, which also depends on whether the particles are plastic particles comprising residual moisture. Depending on the induced polarization, the inhomogeneous external electric field, in which the field strength exhibits a pronounced gradient, exerts different forces on the particles. These different forces deflect the particles moved through the inhomogeneous external electric field differently. In this way, the plastic particles comprising residual moisture, which are again subjected to drying, may be further selectively separated. The separation on the basis of a different polarizability may be carried out simultaneously with the separation of the ferromagnetic and/or electrically conductive particles, i.e. within a combined separating device.

In an embodiment of the method according to the present disclosure, the plastic particles comprising residual moisture, which may form the portion of said one fraction that is again subjected to drying as completely as possible, can be selected particularly easily if the particles, already before being brought into contact with the liquid, are adjusted to a particle size in the range from 1 mm to 10 mm with an accuracy of +/−1.5 mm or better. In this way, the particles exhibit, for example, at least approximately equally sized specific surfaces which are wetted with the liquid, which must be dried again and at which the particles can be electrostatically charged.

The particles may be brought into contact with the liquid by being suspended in the liquid in order to separate them from other particles on the basis of their density. Alternatively or additionally, the particles may be brought into contact with the liquid in order to wash the particles with the liquid. Furthermore, the particles may have unintentionally come into contact with the liquid during outdoor storage or otherwise.

The particles may be subjected to drying by heating the particles and the liquid, for example by convection and/or infrared radiation, in order to evaporate the liquid. Alternatively or additionally, the particles may be subjected to drying by being exposed, together with the liquid, to a flow of dry air, which absorbs and removes the evaporating liquid. Furthermore, a pressure in the surroundings of the particles may be reduced in order to promote evaporation of the liquid. Moreover, adhering liquid may, at the beginning of the drying process, be removed from the particles, for example by suction or centrifugal separation and without evaporation.

In order to subject the particles to electrostatic charging, they may be rubbed against one another and/or exposed to an electrical discharge. Further possibilities for electrostatic charging of particles are also known to a person skilled in the art.

After electrostatic charging, the particles may be conveyed by means of a grounded metallic conveyor. Then, said one fraction, the particles of which exhibit no electrostatic charges, falls from a front end of the conveyor. As has already been indicated, the particles of this fraction comprise not only particles which were not electrostatically charged at all, but also particles which lose their charges again through contact with the grounded metallic conveyor.

By means of a further dielectric conveyor arranged at a free distance above the grounded metallic conveyor, which is thus formed in particular from a dielectric material at its surface, plastic particles having high specific electrostatic charges and low electrical conductivities can be removed. These plastic particles are attracted by the dielectric conveyor away from the grounded metallic conveyor and are then transported away while adhering to the surface thereof.

An apparatus according to the present disclosure for carrying out the method according to the present disclosure comprises a dryer configured to subject the particles, which have previously been in contact with the liquid, to drying. A charging device of the apparatus is configured and arranged to subject the particles, after drying in the dryer, to electrostatic charging; and a fractionating device of the apparatus is configured and arranged to separate the particles, after electrostatic charging in the charging device, into different fractions depending on their specific electrostatic charges and/or electrical conductivities, wherein the particles of one of the different fractions exhibit no electrostatic charges. Furthermore, the apparatus according to the present disclosure comprises a return device configured and arranged to return at least a portion of said one fraction, the particles of which exhibit no electrostatic charges, wherein said portion comprises plastic particles comprising residual moisture, back into the dryer or into a further dryer connected to the charging device, in order to subject the portion of said one fraction again to drying and subsequent electrostatic charging with subsequent separation into the different fractions.

The apparatus may further comprise a metal separator configured and arranged to separate ferromagnetic and/or electrically conductive particles from said one fraction before the portion of said one fraction is subjected to further drying. This metal separator may comprise an electromagnet and/or an eddy current separator.

Furthermore, the apparatus may comprise a separating device configured and arranged to separate particles from said one fraction which exhibit an electrical polarizability different from that of the plastic particles comprising residual moisture from the liquid before the portion of said one fraction is subjected to further drying. The separating device may generate an inhomogeneous electric field in order to deflect the particles to different extents depending on their electrical polarizability through interaction with the inhomogeneous external electric field. In practice, this separating device may be combined with a metal separator to form a combined separating device.

Furthermore, the apparatus may comprise a comminutor and a classifying device formed and arranged to adjust the particles, before they are brought into contact with the liquid, to a particle size in the range from 1 mm to 10 mm with a maximum tolerance of +/−1.5 mm or of only +/−1.0 mm.

Furthermore, a gravity separator may be provided which is formed to separate the particles suspended in the liquid from other particles on the basis of their density. Alternatively or additionally, a washing device may be provided which is formed to wash the particles with the liquid or with a further liquid.

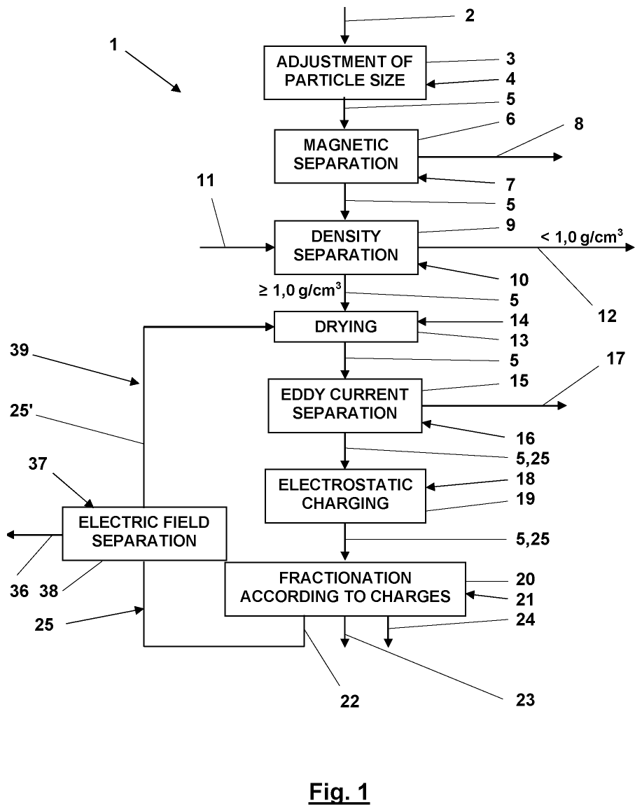

Referring now in greater detail to the drawings, FIG. 1 illustrates an embodiment of the method according to the present disclosure and, at the same time, of the structure of an apparatus 1 according to the present disclosure. A starting material 2 consists of objects of different size and different composition. In an adjustment 3 of a particle size, the starting material 2 is adjusted to a uniform particle size by means of a comminutor and a classifying device 4. The comminutor may comprise a mill, and the classifying device may operate with sieves. The resulting particles 5 exhibit a size that is as uniform as possible in the range from 1 to 10 mm with an accuracy of at least +/−1.5 mm. In a magnetic separation 6 in a magnetic separator 7, ferromagnetic particles 8 are separated from the particles 5. In addition to ferromagnetic metal particles, the ferromagnetic particles 8 also comprise particles 5 made of plastics rendered ferromagnetic by the addition of ferromagnetic metal particles.

In a subsequent density separation 9 in a gravity separator 10, the particles 5 are separated in a liquid 11, for example water, into particles of different density, wherein, in the present example, floating particles 12 having a density smaller than 1 g/cm³ are separated off and further processed elsewhere. The remaining particles 5 are subjected to drying 13 in a dryer 14. By means of eddy current separation 15 in an eddy current separator 16, electrically conductive particles 17 are removed. In addition to non-ferromagnetic metal particles, the electrically conductive particles 17 also comprise particles made of electrically conductive plastics. The remaining particles 5 substantially consist of plastic particles 25 and are subjected to electrostatic charging 19 in a charging device 18, such that they are electrostatically charged as far as possible. This is followed by fractionation 20 of the particles 5 depending on their electrostatic charges in a fractionation device 21.

The resulting fractions 22 to 24 of the particles 5 comprise a fraction 22 into which plastic particles 25′ comprising residual moisture fall, which, due to their residual moisture of liquid 11, were not electrostatically chargeable in the electrostatic charging 19 or quickly lost their charges again due to their residual moisture. If the electrostatic charging 19 is not preceded by an eddy current separation 15, the electrically conductive particles 17 also fall into fraction 22, and if no magnetic separation 6 is provided upstream, the ferromagnetic particles 8, at least insofar as they are simultaneously electrically conductive particles, likewise fall into fraction 22. In these cases, the electrically conductive particles 17 and/or the magnetic particles 8 may be separated from fraction 22 by means of a magnetic separator 7 and/or an eddy current separator 16.

Before the plastic particles 25 of fraction 22 are returned by a return device 39 back to the drying 13 in the dryer 14, plastic particles 36 which as such are not electrostatically chargeable may additionally be separated from the plastic particles 25 of fraction 22 in an electric-field separator 37 by means of separation 38 in an electric field having a pronounced gradient of the electric field strength. The separation of the plastic particles 36 which as such are not electrostatically chargeable from the plastic particles 25′ comprising residual moisture takes place on the basis of their polarization properties. This separation 38 may, just like the eddy current separation 15 and the magnetic separation 6, also be carried out at an earlier point in time, but in particular after the eddy current separation 15 and the magnetic separation 6, such that substantially only plastic particles 36 which as such are not electrostatically chargeable are separated off. From fraction 22, preferably only the plastic particles 25′ comprising residual moisture are returned to the drying 13 in the dryer 14. The further drying 13 taking place in the dryer 14 serves to reduce the residual moisture of the plastic particles 25′ comprising residual moisture to such an extent that, during the subsequently repeated electrostatic charging 19, charging occurs on the basis of the composition of the plastic particles 25, such that their subsequent separation into fractions 23 and 24 can likewise take place on the basis of the composition of the plastic particles 25.

By returning the plastic particles 25′ comprising residual moisture to the drying 13, the drying 13 can be adjusted such that it does not establish, for all particles 5 passing through once, a residual moisture content of 0.2 percent by weight, as is typically required for successful electrostatic separation by electrostatic charging 19 and subsequent fractionation 20 depending on the specific electrostatic charges and/or electrical conductivities of the plastic particles 25. Rather, the drying 13 can be optimized with respect to its energy requirement, wherein it is deliberately accepted that, during a single pass through the drying 13, a greater proportion of the particles 5 does not reach the residual moisture content of 0.2 percent by weight. At least insofar as these are plastic particles 25, however, they are collected as plastic particles 25′ comprising residual moisture during fractionation 20 in fraction 22 and returned to the drying 13. In practice, a considerable saving in energy for drying of at least 10%, and in some cases also at least 20%, can thereby be achieved, which is of considerable importance for the economic efficiency of the overall method.

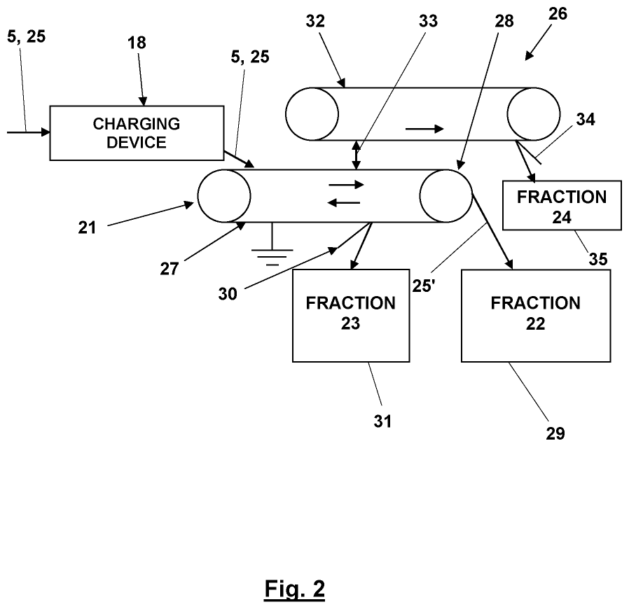

FIG. 2 illustrates a concrete embodiment of an electrostatic separator 26. The electrostatic separator 26 comprises the charging device 18 for the electrostatic charging 19 of the particles 5 in the form of plastic particles 25. The charging device 18 may, for example, comprise a conveyor screw rotating in a jacket made of dielectric material, which conveyor screw is likewise made of dielectric material, such that the particles 5 rub against one another in the charging device 18 and are thereby electrostatically charged. Electrostatic charging 19 of the particles 5 by friction may also be generated in a vibratory conveyor or in a material vortex flow. Alternatively, the charging device 18 may expose the particles 5 to an electrical discharge of a high voltage in order to electrostatically charge the particles 5. The particles 5 electrostatically charged as far as possible are conveyed onto a metallic conveyor belt 27 of the fractionation device 21, which is grounded. On this conveyor belt 27, all electrically conductive particles 5 lose their charges. Thus, electrically conductive particles fall from the front end 28 of the conveyor belt 27 into a container 29 for fraction 22.

Likewise, the plastic particles 25′ comprising residual moisture fall into the container 29 because they were either not electrostatically charged at all in the charging device 18 or likewise lost their charges again on the grounded metallic conveyor belt 27. Plastic particles 25 which are not electrostatically chargeable for other reasons also enter fraction 22. The next fraction 23 of the particles adheres, due to their specific electrostatic charges, to the underside of the grounded metallic conveyor belt 27 and is brushed therefrom into a container 31 by means of a brush device 30. Particles charged with particularly high specific electrostatic charges are attracted upwardly away from the conveyor belt 27 by a conveyor belt 32 made of a dielectric material, which is arranged at a free distance 33 above the conveyor belt 27, and are brushed therefrom into a container 35 for fraction 24 by means of a brush device 34. Thus, plastic particles 25 made of silicone enter fraction 24. Other electrostatically chargeable plastic particles 25, by contrast, are found in fraction 23. Instead of by means of the brush devices 30 and 34, the respective electrostatically charged particles 5 may also be removed from the respective conveyor belt 27 or 32 by applying an electric field.

Many variations and modifications may be made to the preferred embodiments of the invention without departing substantially from the spirit and principles of the invention. All such modifications and variations are intended to be included herein within the scope of the present invention, as defined by the following claims.

We claim:

1. A method for separating particles comprising plastic particles of different compositions, the method comprising:
subjecting the particles, which have previously been in contact with a liquid, to drying so as to remove the liquid therefrom;
subjecting the particles to electrostatic charging after the drying;
separating the particles, after the electrostatic charging, into different fractions depending on at least one of specific electrostatic charges or electrical conductivities of the particles, wherein the particles of one fraction of the different fractions exhibit no electrostatic charges; and
again subjecting at least a portion of the one fraction, the particles of which exhibit no electrostatic charges after the electrostatic charging, to drying and subsequent electrostatic charging, wherein the portion comprises plastic particles comprising residual moisture from the liquid, and thereafter separating the portion into the different fractions depending on the at least one of specific electrostatic charges or electrical conductivities of the particles thereof.

2. The method of claim 1, further comprising, before again subjecting the portion of the one fraction to drying, separating at least one of ferromagnetic or electrically conductive particles from the portion.

3. The method of claim 2, wherein separating the electrically conductive particles comprises inducing eddy currents in the electrically conductive particles and subjecting the portion of the one fraction to an external magnetic field such that the electrically conductive particles are accelerated away from non-electrically conductive particles through interaction with the external magnetic field.

4. The method of claim 1, further comprising, before again subjecting the portion of the one fraction to drying, separating particles that exhibit an electrical polarizability different from that of the plastic particles comprising residual moisture from the liquid.

5. The method of claim 4, wherein separating the particles that exhibit the different electrical polarizability comprises moving the portion of the one fraction through an inhomogeneous electric field such that the particles of the one fraction are deflected to different extents depending on the electrical polarizability thereof through interaction with the inhomogeneous electric field.

6. The method of claim 1, wherein, before being brought into contact with the liquid, a particle size of the particles is adjusted to a value in a range from 1 mm to 10 mm with a maximum tolerance of +/−1.5 mm.

7. The method of claim 1, wherein the particles are suspended in the liquid to separate the particles from other particles on a basis of density.

8. The method of claim 1, wherein the particles are washed with the liquid.

9. The method of claim 1, wherein subjecting the particles to drying comprises at least one of:
heating the particles and the liquid;
exposing the particles and the liquid to a flow of dry air; or
reducing a gas pressure in surroundings of the particles.

10. The method of claim 1, wherein subjecting the particles to electrostatic charging comprises at least one of:
subjecting the particles to friction; or
exposing the particles to an electrical discharge.

11. The method of claim 1, further comprising, after the electrostatic charging, conveying the particles by a grounded metallic conveyor, wherein the particles of the one fraction, which exhibit no electrostatic charges, fall from a front end of the grounded metallic conveyor.

12. The method of claim 11, further comprising removing plastic particles having high specific electrostatic charges and low electrical conductivities by a dielectric conveyor arranged at a free distance above the grounded metallic conveyor.

13. An apparatus for separating particles comprising plastic particles of different compositions, the apparatus comprising:
a dryer configured to subject particles, which have previously been in contact with a liquid, to drying;
a charging device configured to subject the particles, after the drying in the dryer, to electrostatic charging;
a fractionating device configured to separate the particles, after the electrostatic charging, into different fractions depending on at least one of specific electrostatic charges or electrical conductivities of the particles, wherein the particles of one fraction of the different fractions exhibit no electrostatic charges; and
a return device configured to return at least a portion of the one fraction, the particles of which exhibit no electrostatic charges, back into the dryer or into a further dryer connected to the charging device, wherein the portion comprises plastic particles comprising residual moisture from the liquid, such that the portion of the one fraction is again subjected to drying, subsequent electrostatic charging, and subsequent separation into the different fractions.

14. The apparatus of claim 13, further comprising a separator configured to separate ferromagnetic and/or electrically conductive particles before the portion of the one fraction is again subjected to drying.

15. The apparatus of claim 14, wherein the separator comprises at least one of a magnetic separator or an eddy current separator.

16. The apparatus of claim 13, further comprising a separator configured to separate particles that exhibit an electrical polarizability different from that of the plastic particles comprising residual moisture before the portion of the one fraction is again subjected to drying.

17. The apparatus of claim 16, wherein the separator comprises an electric-field separator configured to generate an inhomogeneous electric field to deflect the particles differently depending on the electrical polarizability thereof through interaction with the inhomogeneous electric field.

18. The apparatus of claim 13, further comprising a comminutor and a classifying device configured to adjust a particle size of the particles, before the particles are brought into contact with the liquid, to a value in a range from 1 mm to 10 mm with a maximum tolerance of +/−1.5 mm.

19. The apparatus of claim 13, further comprising a gravity separator configured to separate the particles suspended in the liquid from other particles on a basis of density.

20. The apparatus of claim 13, further comprising a washing device configured to wash the particles with the liquid.
